(19) United States
(12) Patent Application Publication
(10) Pub. No.: US 2015/0149543 A1
(43) Pub. Date: May 28, 2015

(54) METHOD FOR CONTENTS SHARING SERVICE AND SERVER APPLIED TO THE SAME

(71) Applicant: CALL GATE CO., LTD., Seoul (KR)

(72) Inventors: Yongjin KIM, Seoul (KR); Hwanwoo NAM, Seoul (KR)

(73) Assignee: CALL GATE CO., LTD., Seoul (KR)

(21) Appl. No.: 14/151,013

(22) Filed: Jan. 9, 2014

(30) Foreign Application Priority Data
Nov. 28, 2013 (KR) 10-2013-0146604

(51) Int. Cl. H04L 29/08

(52) U.S. Cl. CPC H04L 67/10; H04L 67/16
USPC 709/204

(57) ABSTRACT

Disclosed are a contents sharing service method and a server applied to the same. In regard to a voice call connection made between an originating terminal and a terminating terminal, the terminating terminal sets contents which the terminating terminal desires to share with the originating terminal and the originating terminal identifies the set contents to be shared. Accordingly, Social Network Service (SNS) contents registered in connection with a plurality of SNSs, which a subscriber of the terminating terminal has joined, can be easily shared with a subscriber of the originating terminal as the contents to be shared.

### CROSS-REFERENCE TO RELATED APPLICATION

This application claims priority from and the benefit under 35 U.S.C. §119(a) of Korean Patent Application No. 10-2013-0146604, filed on Nov. 28, 2013, which is hereby incorporated by reference for all purposes as if fully set forth herein.

### BACKGROUND OF THE INVENTION

1. Field of the Invention

The present invention relates generally to a method in which a terminating terminal sets contents which the terminating terminal desires to share with an originating terminal and the originating terminal identifies the set contents to be shared in regard to a voice call connection made between the terminating terminal and the originating terminal.

2. Description of the Prior Art

Recently, with the spread of smart phones, the use of applications and mobile web contents have greatly increased and various types of Social Network Services (SNSs) using the applications and mobile web contents have been created.

Accordingly, SNS subscribers share SNS contents such as a picture, a schedule, restaurant information, and hobby information between the subscribers through various SNSs as well as shares their thoughts or opinions.

However, most SNS subscribers generally simultaneously subscribe to and use a plurality of SNSs rather than use only one SNS.

Accordingly, the SNS subscribers may individually set targets to share SNS contents in every SNS which the subscribers join or additionally join a new SNS in order to identify SNS contents which another person desires to share, which makes the subscribers feel inconvenience.

### SUMMARY OF THE INVENTION

The present invention has been made to solve the above mentioned problems, and an aspect of the present invention is to set contents which a terminating terminal desires to share with an originating terminal in regard to a voice call connection made between the originating terminal and the terminating terminal and allow the originating terminal to identify the set contents to be shared, thereby easily sharing, between the terminating terminal and the originating terminal, registered SNS contents related to a plurality of SNSs, which a subscriber of the terminating terminal has joined, as the contents to be shared.

In accordance with an aspect of the present invention, a service server is provided. The service provider includes: an identifier for identifying whether there are contents to be shared which a terminating terminal sets to share with an originating terminal according to a service request received in regard to a voice call connection between the terminating terminal and the originating terminal; a generator for generating a sharing service screen to include the contents to be shared when it is identified that there are the contents which the terminating terminal sets to share with the originating terminal; and a provider for providing the sharing service screen to the originating terminal to allow the originating terminal to identify the contents which the terminating terminal sets to share through the sharing service screen.

The generator may generate a setting service screen related to a setting of the contents to be shared when the identifier identifies that there are no contents which the terminating terminal sets to share with the originating terminal or the provider may provide the sharing service screen to the originating terminal, and the provider provides the setting service screen to the terminating terminal to allow the terminating terminal to newly set contents to be shared with the originating terminal or to change and then set the contents.

The contents to be shared may include Social Network Service (SNS) contents registered in connection with one or more SNSs which the terminating terminal designates to allow the originating terminal to access among a plurality of SNSs related to the terminating terminal, and the generator may acquire the SNS contents registered in an SNS server providing each of the one or more SNSs from the SNS server and generate the sharing service screen to include the acquired SNS contents as the contents to be shared.

The sharing service screen and the setting service screen may include a new contents input area through which new contents related to the one or more SNSs can be input, and the service server may further include a transmitter for, when the new contents are input through the new contents input area by the originating terminal and the terminating terminal, transmitting the new contents to the SNS server providing each of the one or more SNSs and registering the new contents as the SNS contents.

A service application for receiving the sharing service screen or the setting service screen may be installed in the originating terminal and the terminating terminal, and the service request may be received from at least one of the originating terminal and the terminating terminal of which identification information has been identified in regard to the voice call connection through the service application.

In accordance with another aspect of the present invention, an operation method of a service server is provided. The operation method includes: identifying whether there are contents which a terminating terminal sets to share with an originating terminal according to a service request received in regard to a voice call connection made between the originating terminal and the terminating terminal; generating a sharing service screen to include the contents to be shared when it is identified that there are the contents which the terminating terminal sets to share with the originating terminal; and providing the sharing service screen to the originating terminal to allow the originating terminal to identify the contents which the terminating terminal sets to share through the sharing service screen.

The method may further include: generating a setting service screen related to a setting of the contents to be shared when it is identified that there are no contents which the terminating terminal sets to share with the originating terminal in the identifying of whether there are the contents; and providing the setting service screen and newly setting the contents which the terminating terminal desires to share with the originating terminal through the setting service screen or changing and then setting the contents.

The contents to be shared may include SNS contents registered in connection with one or more SNSs which the terminating terminal designates to allow the originating terminal to access among a plurality of SNSs related to the terminating terminal, and the generating of the sharing service screen may include: acquiring the SNS contents registered in an SNS server providing each of the one or more SNSs from the SNS server; and generating the sharing service screen to include the acquired SNS contents as the contents to be shared.

The sharing service screen and the setting service screen may include a new contents input area through which new contents related to the one or more SNSs can be input, and the operation method may further include, when the new contents are input through the new contents input area by the originating terminal and the terminating terminal, transmitting the new contents to the SNS server providing each of the one or more SNSs and registering the new contents as the SNS contents

A service application for receiving the sharing service screen or the setting service screen may be installed in the originating terminal and the terminating terminal, and the service request may be received from at least one of the originating terminal and the terminating terminal of which identification information have been identified in regard to the voice call connection through the service application.

According to a contents sharing service method and a service applied to the same according to the present invention, in regard to a voice call connection made between an originating terminal and a terminating terminal, the terminating terminal sets contents which the terminating terminal desires to share with the originating terminal and the originating terminal identifies the set contents to be shared. Therefore, registered SNS contents related to a plurality of SNSs, which a subscriber of the terminating terminal has joined, can be easily shared with the originating terminal as the contents to be shared.

### BRIEF DESCRIPTION OF THE DRAWINGS

The above and other objects, features and advantages of the present invention will be more apparent from the following detailed description in conjunction with the accompanying drawings, in which:

FIG. 1 illustrates a schematic configuration of a contents sharing service system according to an embodiment of the present invention;

FIG. 2 illustrates a configuration of a service server according to an embodiment of the present invention;

FIGS. 3A to 3C are views describing a sharing policy according to an embodiment of the present invention;

FIG. 4 is a flowchart schematically describing an operation flow in a contents sharing service system according to a first embodiment of the present invention;

FIG. 5 is a flowchart schematically describing an operation flow in a contents sharing service system according to a second embodiment of the present invention;

FIG. 6 is a flowchart schematically describing an operation flow in a contents sharing service system according to a third embodiment of the present invention;

FIG. 7 is a flowchart schematically describing an operation flow in a contents sharing service system according to a fourth embodiment of the present invention;

FIG. 8 is a flowchart schematically describing an operation flow in a contents sharing service system according to a fifth embodiment of the present invention;

FIG. 9 is a flowchart schematically describing an operation flow in a contents sharing service system according to a sixth embodiment of the present invention; and

FIG. 10 is a flowchart schematically describing an operation flow in a service server according to an embodiment of the present invention.

### DETAILED DESCRIPTION OF THE EXEMPLARY EMBODIMENTS

Hereinafter, an embodiment of the present invention will be described with reference to the accompanying drawings.

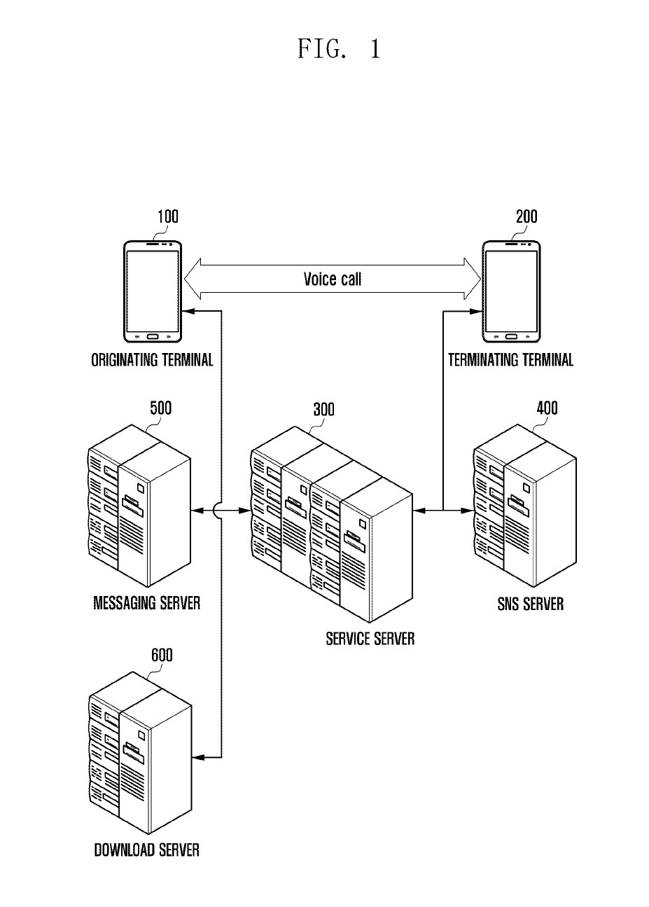

FIG. 1 illustrates a contents sharing service system according to an embodiment of the present invention.

As illustrated in FIG. 1, the contents sharing service system according to the embodiment of the present invention includes an originating terminal 100 that sends a voice call, a terminating terminal 200 that receives a voice call, and a service server 300 that allows the originating terminal 100 to identify contents which the terminating terminal 200 sets to shared with the originating terminal 100 in regard to a voice call connection made between the originating terminal 100 and the terminating terminal 200.

In addition to the above described components, the contents sharing service system according to the embodiment of the present invention may further include a Social Network Service (SNS) server 400 that provides a particular SNS used by a subscriber of the terminating terminal 200, a messaging server 500 that transmits a message related to the contents to be shared, and a download server 600 that provides an application related to an identification of the contents to be shared.

First, the originating terminal 100 or the terminating terminal 200 can establish a voice call connection therebetween, and refer to a user device that sets the contents to be shared or has an installed service application required to be executed to identify the contents to be shared.

For example, the originating terminal 100 and the terminating terminal 200 may correspond to a smart phone, a notebook computer, a tablet Personal Computer (PC), a Personal Digital Assistant (PDA) or the like, but are not limited thereto. Also, the originating terminal 100 and the terminating terminal 200 may correspond to all devices which can make a voice call and install and execute the service application.

The service application refers to an application that allows the contents to be shared to be identified through a sharing service screen provided by the server 300 when the service application is installed and executed in the originating terminal 100, and refers to an application that allows the contents to be shared to be identified through a setting service screen provided by the service server 300 when the service application is installed in the terminating terminal 200.

The service server 300 refers to a server that performs a series of designated operations in which the terminating terminal 200 sets contents to be shared and the originating terminal 100 can identify the set contents to be shared in regard to a voice call connection made between the originating terminal 100 and the terminating terminal 200.

The SNS server 400 refers to a server that provides a particular SNS among a plurality of SNSs which a subscriber of the terminating terminal 200 uses and may provide SNS contents (for example, image, dynamic image, and text) registered by the subscriber of the terminating terminal 200 to the service server 300.

The messaging server 500 refers to a server that transmits a message requested by the service server 300 to the originating terminal 100, and may correspond to, for example, a Short Message Service Center (SMSC) or a mail server.

A message transmitted from the messaging server 500 is related to a messaging service provided by a mobile platform itself, and may correspond to, for example, Google Cloud Messaging (GCM) and Cloud to Device Message (C2DM) provided by Android, and Push Notification Service (PNS) provided by I-OS.

The download server 600 refers to a server that provides an application which the originating terminal 100 desires to download and provides an application developed to fit a mobile platform (for example, Android or I-OS) of the originating terminal 100.

Meanwhile, according to an embodiment of the present invention, the originating terminal 100 can identify SNS contents registered in a plurality of SNSs, which the subscriber of the terminating terminal 200 has joined, as the contents to be shared.

For example, the subscriber of the terminating terminal 200 may sometimes desire to share SNS contents registered in all or some of the SNSs, which the subscriber has joined, with the subscriber of the originating terminal 100 as the contents to be shared.

In this case, the subscriber of the terminating terminal 200 should identify SNSs, which the subscriber of the originating terminal 100 has joined, among the SNSs, which the subscriber of the terminating terminal 200 has joined, access the identified SNSs one by one, and designate the subscriber of the originating terminal 100 as a target to share the SNSs.

When the subscriber of the terminating terminal 200 desires to share a particular SNS, which the subscriber of the originating terminal 100 has not joined, with the subscriber of the originating terminal 100, the terminating terminal 200 should induce the subscriber of the originating terminal 100 to join the service by informing of the particular SNS. Then, after the subscriber of the originating terminal 100 has joined the particular SNS, the subscriber of the terminating terminal 200 should designate the subscriber of the originating terminal 100 as a target to share the SNS.

When the subscriber of the originating terminal 100 has not joined receive a list of SNSs, which the subscriber of the terminating terminal 200 has joined, from the subscriber of the terminating terminal 200, the subscriber of the originating terminal 100 should identify which SNSs the subscriber of the terminating terminal 200 has joined by itself. Further, after identifying the SNSs, which the subscriber of the terminating terminal 200 has joined, the subscriber of the originating terminal 100 should check SNSs which the subscriber of the terminating terminal 200 desires to share one by one.

Even though the subscriber of the originating terminal 100 identifies a particular SNS, which the subscriber of the terminating terminal 200 desires to share, by itself, if the identified particular SNS is not a service, which the subscriber of the originating terminal 100 has joined, the subscriber of the originating terminal is necessarily required to join the service of the corresponding SNS, which makes subscriber feel the inconvenience.

As described above, when the SNS subscribers simultaneously join a plurality of SNSs, the inconvenience due to the contents sharing may increase and the inconvenience may act as a hindrance to the activation of the SNS service.

Accordingly, an embodiment of the present invention provides, when there are contents, which the subscriber of the terminating terminal 200 desires to share with the subscriber of the originating terminal 100, a method in which the originating terminal 100 sets the contents to be shared and the originating terminal 100 can easily identify the contents to be shared. Hereinafter the method will be described in detail.

First, the service server 300 performs a function of receiving a service request.

More specifically, the service server 300 receives a service request for using a contents sharing service from the originating terminal 100 that sends a voice call during a voice call connection process between the originating terminal 100 and the terminating terminal 200, the terminating terminal 200 that receives the voice call, or both the originating terminal 100 and the terminating terminal 200.

By executing an installed service application according to the origination of the voice call, the originating terminal 100 may acquire identification information (phone number) of the originating terminal 100 and the terminating terminal 200 from its own mobile platform (for example, Android) through the executed service application and transmit a service request including the identification information (phone number) of the originating terminal 100 and the terminating terminal 200 to the service server 300 together with an indicator that informs of the origination of the voice call.

In contrast, by executing an installed service application according to the reception of the voice call, the terminating terminal 200 may acquire identification information (phone number) of the originating terminal 100 and the terminating terminal 200 from a mobile platform (for example, Android) through the executed service application and transmit a service request including the identification information (phone number) of the originating terminal 100 and the terminating terminal 200 to the service server 300 together with an indicator that informs of the reception of the voice call.

Further, the service server 300 performs a function of identifying whether a contents sharing service is possible.

More specifically, the service server 300 identifies whether a contents sharing service with respect to the originating terminal 100 and the terminating terminal 200 is possible according to the reception of the service request from the originating terminal 100 or the terminating terminal 200.

When the service server 300 receives the service request from the originating terminal 100, the service server 300 first identifies whether the subscriber of the terminating terminal 200 has joined the contents sharing service. When the subscriber of the terminating terminal 200 has joined the contents sharing service, the service server 300 identifies whether there are contents which the terminating terminal 200 desires to share with the originating terminal 100.

That is, the service server 300 may identify whether the contents exist which the terminating terminal 200 desires to share with the originating terminal 100 by identifying whether there is an SNS which the subscriber of the terminating terminal 200 designates to share with the subscriber of the originating terminal 100 in a plurality of SNSs which the subscriber of the terminating terminal 200 uses.

Meanwhile, the subscriber of the terminating terminal 200 may set a plurality of sharing groups (for example, friend, family, and co-worker) which can share a plurality of SNSs used by the subscriber of the terminating terminal 200 and differentially designate SNSs to be shared by respective sharing groups.

To this end, the terminating terminal 200 transmits a contents sharing request to the SNS server 400 that provides each SNS to inform of the desire to share the corresponding SNS and accordingly allows the SNS server 400 to provide authentication information corresponding to authority to access the contents to be shared to the service server 300.

Then, the service server 300 identifies a sharing group including the originating terminal 100 among the plurality of sharing groups set by the subscriber of the terminating terminal 200 based on the identification information (for example, phone number) of the originating terminal 100, and thus can identify the SNS which the subscriber of the terminating terminal 200 designates to share with the subscriber of the originating terminal 100.

The contents to be shared refer to SNS contents registered in the SNS which the subscriber of the terminating terminal 200 designates to share with the subscriber of the originating terminal 100.

In contrast, when the service server 300 receives the service request from the terminating terminal 200, the service server 200 identifies whether the contents exist which subscriber of the terminating terminal 200 desires to share with the originating terminal 100 as described above. When the service server 200 identifies that the contents to be shared exist, the service server 200 identifies whether a service application is installed in the originating terminal 100.

When the contents which the subscriber of the terminating terminal 200 desires to share with the subscriber of the originating terminal 100 exist but the service application is not installed in the originating terminal 100, the originating terminal 100 may download and install the service application.

To this end, the service server 300 is required to separately manage whether the applications for the originating terminal 100 and the terminating terminal 200 are installed.

Further, when the contents which the subscriber of the terminating terminal 200 desires to share with the subscriber of the originating terminal 100 does not exist, the service server 300 generates a setting service screen related to a setting of the contents to be shared and provides the generated setting service screen to the terminating terminal 200. Such an operation corresponds to all of a case where the service request is received from the originating terminal 100 and a case where the service request is received from the terminating terminal 200.

Meanwhile, the terminating terminal 200 may receive a voice call from the originating terminal 100 in a state where a voice call connection is difficult (for example, in a cinema, in class, or in a meeting). In this event, by stopping the voice call connection, the service server 300 may provide a voice call blocking service corresponding to an additional service in which the originating terminal 100 identifies contents which the terminating terminal 200 sets to share.

Of course, for the above voice call blocking service, the service server 300 is required to perform a service setting in advance in the terminating terminal 200.

At this time, in a service setting process, the service server 300 allows the subscriber of the terminating terminal 200 to set contents to share with the subscriber of the originating terminal 100 and sets a time point when the voice call blocking service is provided.

The time point when the voice call blocking service is provided may be set as, for example, a time point desired by the subscriber of the terminating terminal 200 during a voice call connection, that is, a time point when a service request is received from the terminating terminal 200 during the voice call connection as well as a time point when a voice call is received from the originating terminal 100.

Further, the service server 300 performs a function of generating a sharing service screen.

More specifically, when the service server 300 identifies that the contents exist which the subscriber of the terminating terminal 200 desires to share with the subscriber of the originating terminal 100, the service server 300 generates a sharing service screen including the contents to be shared.

The service server 200 identifies the SNS which the subscriber of the terminating terminal 200 designates to share with the subscriber of the originating terminal 100 and acquires SNS contents registered by the subscriber of the terminating terminal 200 from the SNS server 300 providing the corresponding SNS. Accordingly, the service server 300 can generate the sharing service screen including the acquired SNS contents as the contents to be shared.

Further, the service server 300 performs a function of providing the sharing service screen.

More specifically, when the sharing service screen is generated, the service server 300 provides the sharing service screen to the originating terminal 100 and thus may allow the subscriber of the originating terminal 100 to identify, through the sharing service screen, the contents which the subscriber of the terminating terminal 200 desires to share.

The service server 300 provides authentication information required for an access to the SNS server 400 together with access information on each of the contents to be shared included in the sharing service screen. Accordingly, when the originating terminal 100 selects the contents to be shared in the sharing service screen, the service server 300 allows the originating terminal 100 to directly access the contents to be shared, that is, SNS contents registered in the SNS server 400 without separate service subscription and authentication processes in the SNS server 400.

When the service server 300 does not provide the access information and authentication information on each of the contents to be shared included in the sharing service screen and the originating terminal 100 selects the contents to be shared in the sharing service screen, the service server 300 may allow a contents request to be transmitted to the service server 300.

In this event, by transmitting the contents request received from the originating terminal 100 to the SNS server 400, the service server 300 acquires the access information on the corresponding contents to be shared from the SNS server 400 and transmits the access information on the acquired contents to be shared to the originating terminal 100.

In transmitting the contents request received from the originating terminal 100 to the SNS server 400, the service server 300 may transmit in advance the authentication information required for the access to the SNS server 400, so that the originating terminal 100 can access the contents to be shared, that is, SNS contents registered in the SNS server 400 according to the access information on the contents to be shared without separate service subscription and authentication processes in the SNS server 400.

Meanwhile, as described above, in providing the sharing service screen to the originating terminal 100, when the service server 300 does not receive the service request from the originating terminal 100, the service server 300 installs a service application to make the originating terminal 100 receive the sharing service screen or executes an already installed service application.

For example, when the service server 300 does not receive the service request from the originating terminal 100, a state may be expected where the service application is installed in the originating terminal 100 but the service application is not executed.

In this event, the service server 300 transmits a service application execution request to the messaging server 500 and allows the messaging server 500 to transmit a service application execution message to the originating terminal 100, so that the service application installed in the originating terminal 100 is executed and thus the originating terminal 100 may normally receive and display the sharing service screen.

In another example, when the service server 300 does not receive the service request from the originating terminal 100, it may correspond to a case where the service application is not installed in the originating terminal 100.

In this event, the service server 300 transmits a service application download link address to the messaging server 500 and allows the messaging server 500 to transmit the service application download link address to the originating terminal 100, so that the originating terminal 100 downloads a service application suitable for its own mobile platform from the download server 600 and installs the downloaded service application.

Meanwhile, particular contents to be shared which can be included in the sharing service screen may be provided in a form of an application. In this event, in order to identify the particular contents to be shared, the originating terminal 100 should have an application in the same form as that of the particular contents to be shared.

When the originating terminal 100 selects the particular contents to be shared on the sharing service screen, even though the execution of the application is needed according to the service link, the corresponding application may not be installed.

In this event, the originating terminal 100 is required to recognize the non-execution of the application and to download and install the corresponding application from the download server 600. At this time, when a service subscription process is needed in connection with the installation of the application, the originating terminal 100 may register service subscription information according to the corresponding service subscription process in the download server 600 to normally execute the installed application.

Further, the service server 300 performs a function of providing a setting service screen related to a setting of the contents to be shared.

More specifically, when there are no contents which the terminating terminal 200 desires to share with the originating terminal 100 or the sharing service screen is provided to the originating terminal 100, the service server 300 generates a setting service screen related to a setting of the contents to be shared and provides the generated setting service screen to the terminating terminal 200. Then, the terminating terminal 200 newly sets the contents which the terminating terminal 200 desires to share with the originating terminal 100 through the setting service screen or changes and then sets the contents.

Further, the service server 300 performs a function of transmitting new contents.

More specifically, when new contents related to the contents to be shared are input through the sharing service screen by the originating terminal 100, the service server 300 transmits the input new contents to the SNS server 400 and allows the new contents to be registered in the SNS server 400 as new SNS contents.

The new contents may be, for example, an emoticon or a visual image as well as a text, or may be a picture stored in a picture album of the originating terminal 100 or a picture taken by a photographing function of the originating terminal 100 which is activated by the service application of the originating terminal 100.

The new contents may be input through a new contents input area activated by selecting a particular UI button (message input) on the sharing service screen.

Further, after transmitting the new contents transmitted from the originating terminal 100 to the SNS server 400, the service server 300 registers the new contents as update information. Accordingly, when the sharing service screen is generated according to a service request in the future, the registered update information can be used.

In addition, after registering the update information related to the new contents, the service server 300 informs the terminating terminal 200 that the new contents has been registered in the SNS server 400. Accordingly, the terminating terminal 200 may access the SNS server 400 to identify the new contents registered as the new SNS contents.

Meanwhile, the service server 300 also may newly register new contents transmitted from the terminating terminal 200 through the setting service screen by transmitting the new contents to the SNS server 400 as well as the new contents transmitted from the originating terminal 100 through the sharing service screen.

When the service server 300 receives new contents related to one or more SNSs from the terminating terminal 200, the service server 300 transmits the new contents to respective SNS servers 400 and registers the new contents as new SNS contents.

At this time, the service server 300 also may transmit authentication information of the terminating terminal 200 according to a request of the SNS server 400.

For reference, the new contents transmitted from the terminating terminal 200 may be directly transmitted to the SNS server 400 without passing through the service server 300.

Further, after transmitting the new contents transmitted from the terminating terminal 200 to the SNS server 400, the service server 300 registers the new contents as update information. Accordingly, when the sharing service screen is generated according to a service request in the future, the registered update information can be reflected.

The service server 300 receives and registers information on the contents to be shared set by the subscriber of the terminating terminal 200 through the setting service screen as well as the new contents transmitted from the originating terminal 100 trough the setting service screen. Accordingly, the registered information may be reflected when the sharing service screen is generated or the setting service screen is generated in the future.

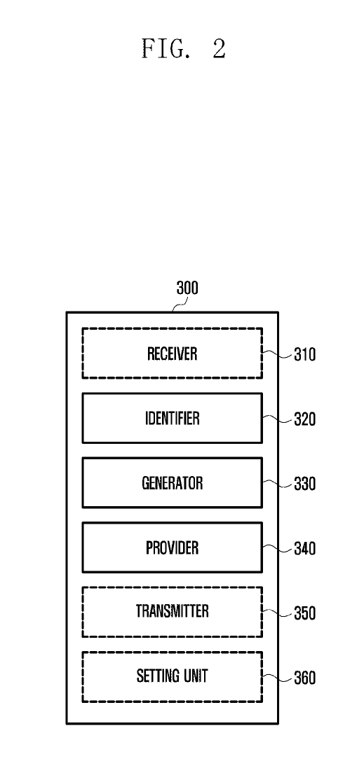

Hereinafter a configuration of the service server 300 according to an embodiment of the present invention will be described in more detail with reference to FIG. 2.

That is, the service server 300 includes an identifier 320 that performs a function of identifying whether a contents sharing service is possible, a generator 330 that generates a sharing service screen or a setting service screen, and a provider 340 that provides the sharing service screen to the originating terminal 100 or provides the setting service screen to the terminating terminal 200.

In addition to the above described components, the service server 300 according to an embodiment of the present invention may further include a receiver 310 that receives a service request from the originating terminal 100 and the terminating terminal 200, a transmitter 350 that transmits new contents received from the originating terminal 100 and the terminating terminal 200, and a setting unit 360 that sets contents which the subscriber of the terminating terminal 200 desires to share with the subscriber of the originating terminal 100.

All or some of the components of the service server 300 including receiver 310, the identifier 320, the generator 330, the provider 340, the transmitter 350, and the setting unit 360 may be implemented by a software module executed by a processor or implemented by hardware.

First, the receiver 310 performs a function of receiving a service request in regard to a voice call connection between the originating terminal 100 and the terminating terminal 200.

More specifically, the receiver 310 receives a service request for using a contents sharing service from the originating terminal 100 that sends a voice call during a voice call connection process between the originating terminal 100 and the terminating terminal 200, the terminating terminal 200 that receives the voice call, or both the originating terminal 100 and the terminating terminal 200.

By executing an installed service application according to the origination of the voice call, the originating terminal 100 may acquire identification information (phone number) of the originating terminal 100 and the terminating terminal 200 from a mobile platform (for example, Android) through the executed service application and transmit a service request including the identification information (phone number) of the originating terminal 100 and the terminating terminal 200 to the service server 300 together with an indicator that informs of the origination of the voice call.

Further, by executing an installed service application according to the reception of the voice call, the terminating terminal 200 may acquire identification information (phone number) of the originating terminal 100 and the terminating terminal 200 from a mobile platform (for example, Android) through the executed service application and transmit a service request including the identification information (phone number) of the originating terminal 100 and the terminating terminal 200 to the service server 300 together with an indicator that informs of the reception of the voice call.

As described above, the reason why the receiver 310 receives the service requests from both the originating terminal 100 and the terminating terminal 200 is that a particular mobile platform (for example, I-OS) does not support an API that acquires identification information (phone number) of the originating terminal 100 and the terminating terminal 200 by executing the service application during the origination or termination of the voice call.

That is, it is to allow the receiver 310 to use the contents sharing service through a counterpart terminal being in the voice call connection even though the originating terminal 100 or the terminating terminal 200 cannot execute the service application due to the nature of the mobile platform in the voice call connection.

Meanwhile, when the receiver 310 receives the service requests from both the originating terminal 100 and the terminating terminal 200, the receiver 310 processes only one of the service requests received from the originating terminal 100 and the terminating terminal 200 according to a priority of a policy. Further, the identifier 320 performs a function of identifying whether the contents sharing service is possible.

More specifically, when the identifier 320 receives the service request from the originating terminal 100, the identifier 300 first identifies whether the subscriber of the terminating terminal 200 has joined the contents sharing service. When the subscriber of the terminating terminal 200 has joined the contents sharing service, the identifier 300 identifies whether there are contents which the terminating terminal 200 desires to share with the originating terminal 100.

That is, the identifier 320 may identify whether the contents exist which the terminating terminal 200 desires to share with the originating terminal by identifying whether there is an SNS which the subscriber of the terminating terminal 200 designates to share with the subscriber of the originating terminal 100 in a plurality of SNSs which the subscriber of the terminating terminal 200 uses.

At this time, the identifier 320 identifies a sharing group including the originating terminal 100 among a plurality of sharing groups set by the subscriber of the terminating terminal 200 based on the identification information (for example, phone number) of the originating terminal 100, and thus can identify the SNS which the subscriber of the terminating terminal 200 designates to share with the subscriber of the originating terminal 100.

In contrast, when the identifier 320 receives the service request from the terminating terminal 200, the identifier 200 identifies whether the contents exist which the subscriber of the terminating terminal 200 desires to share with the originating terminal 100 as described above. When the identifier 320 identifies that the contents to be shared exist, the identifier 320 identifies whether a service application is installed in the originating terminal 100.

When the contents which the subscriber of the terminating terminal 200 desires to share with the subscriber of the originating terminal 100 exist but the service application is not installed in the originating terminal 100, the originating terminal may download the service application through the provider 340 and installs the downloaded service application.

Further, when the identifier identifies that there are no contents which the subscriber of the terminating terminal 200 desires to share with the subscriber of the originating terminal 100, the identifier 320 allows the generator 330 to generate a setting service screen related to a setting of the contents to be shared and the provider 340 to provide the generated setting service screen to the terminating terminal 200.

Meanwhile, the identifier 320 identifies whether the terminating terminal 200 has joined a voice call blocking service. When the terminating terminal 200 has joined the voice call blocking service, the identifier 320 makes a request for stopping a voice call connection to the terminating terminal 200 and allows the originating terminal 100 to identify the contents which the terminating terminal 200 sets to share.

Further, the generator 330 performs a function of generating the sharing service screen.

More specifically, when it is identified that the contents exist which the subscriber of the terminating terminal 200 desires to share with the subscriber of the originating terminal 100, the generator 330 generates the sharing service screen including the contents to be shared.

The generator 330 identifies the SNS which the subscriber of the terminating terminal 200 designates to share with the subscriber of the originating terminal 100 and acquires SNS contents registered by the subscriber of the terminating terminal 200 from the SNS server 300 providing the corresponding SNS. Accordingly, the generator 330 can generate the sharing service screen including the acquired SNS contents as the contents to be shared.

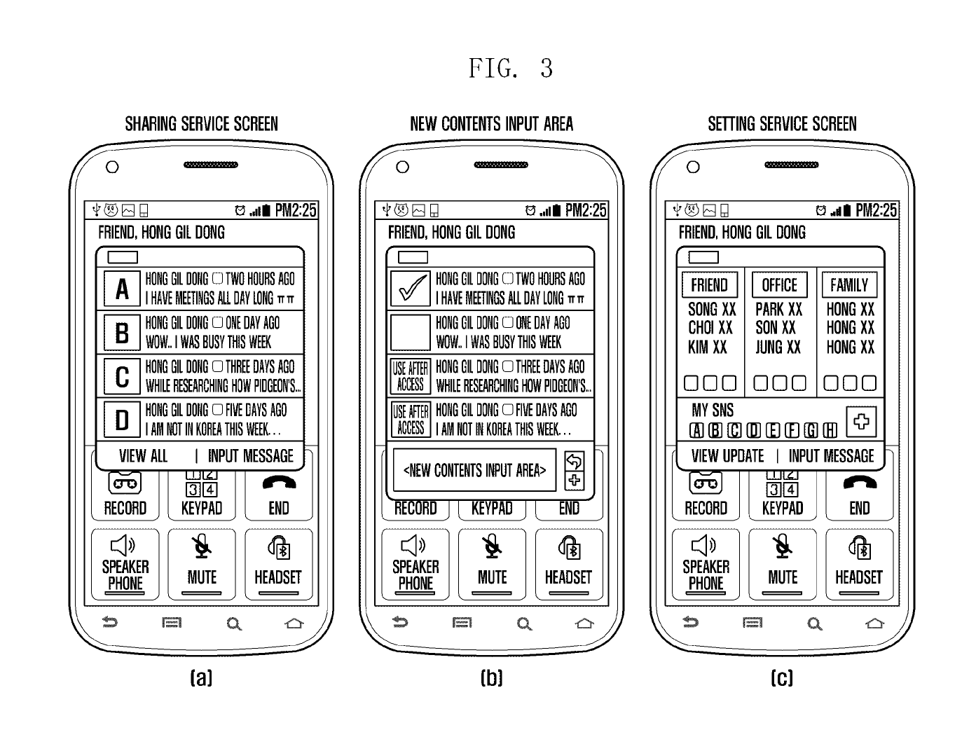

The sharing service screen may be generated to identify schematic matters of the registered SNS contents as the contents to be shared, for each SNS which the subscriber of the terminating terminal 200 designates to share with the subscriber of the originating terminal 100 as illustrated in FIG. 3A.

Meanwhile, the generator 330 receives the update date and time of the SNS contents from the SNS server 400 and compares the update date and time with the contents sharing service date and time of the originating terminal 100. Accordingly, the generator 330 can determine whether the corresponding SNS contents are new contents to be shared with the subscriber of the originating terminal 100.

To this end, the generator 330 is required to separately manage log information of the originating terminal 100 in connection with the use of the contents sharing service and the identification of the contents to be shared.

As described above, when the SNS contents acquired from the SNS server 440 are determined as the new contents to be shared with the subscriber of the originating terminal 100, the corresponding contents to be shared are assigned a tag informing that the contents are new contents, so that the subscriber of the originating terminal 100 can recognize the new contents.

Further, the provider 340 performs a function of providing the sharing service screen.

More specifically, when the sharing service screen is generated, the provider 340 provides the sharing service screen to the originating terminal 100 and thus may allow the subscriber of the originating terminal 100 to identify, through the sharing service screen, the contents which the subscriber of the terminating terminal 200 desires to share.

The provider 340 provides authentication information required for an access to the SNS server 400 together with access information on each of the contents to be shared included in the sharing service screen. Accordingly, when the originating terminal 100 selects the contents to be shared in the sharing service screen, the provider 300 allows the originating terminal 100 to directly access the contents to be shared, that is, SNS contents registered in the SNS server 400 without separate service subscription and authentication processes in the SNS server 400.

When the provider 340 does not provide the access information and authentication information on each of the contents to be shared included in the sharing service screen and the originating terminal 100 selects the contents to be shared in the sharing service screen, the provider 300 may allow a contents request to be transmitted to the provider 340 itself.

In this event, by transmitting the contents request received from the originating terminal 100 to the SNS server 400, the provider 340 acquires the access information on the corresponding contents to be shared from the SNS server 400 and transmits the access information on the acquired contents to be shared to the originating terminal 100.

In transmitting the contents request received from the originating terminal 100 to the SNS server 400, the provider 340 may transmit in advance the authentication information required for the access to the SNS server 400, so that the originating terminal 100 can access the contents to be shared, that is, SNS contents registered in the SNS server 400 according to the access information on the contents to be shared without separate service subscription and authentication processes in the SNS server 400.

Meanwhile, as described above, in providing the sharing service screen to the originating terminal 100, when the provider 340 does not receive the service request from the originating terminal 100, the provider 300 installs a service application to make the originating terminal 100 receive the sharing service screen or executes an already installed service application.

First, when the service request is not received from the originating terminal 100, a state may be expected where the service application is installed in the originating terminal 100 but the service application is not executed.

In this event, the provider 340 transmits a service application execution request to the messaging server 500 and allows the messaging server 500 to transmit a service application execution message to the originating terminal 100, so that the service application installed in the originating terminal 100 is executed and the originating terminal 100 may normally receive and display the sharing service screen.

Next, when the service request is not received from the originating terminal 100, it may correspond to a case where the service application is not installed in the originating terminal 100.

In this event, the provider 340 transmits a service application download link address to the messaging server 500 and allows the messaging server 500 to transmit the service application download link address to the originating terminal 100, so that the originating terminal 100 downloads a service application suitable for its own mobile platform from the download server 600 and installs the downloaded service application.

Further, the provider 340 performs a function of providing a setting service screen related to a setting of the contents to be shared.

More specifically, when there are no contents which the terminating terminal 200 desires to share with the originating terminal 100 or the sharing service screen is provided to the originating terminal 100, the generator 330 generates a setting service screen related to a setting of the contents to be shared.

Further, the provider 340 provides the generated setting service screen to the terminating terminal 200, so that the terminating terminal 200 may newly set the contents which the terminating terminal 200 desires to share with the originating terminal 100 through the setting service screen or changes and then sets the contents.

In the setting service screen, as illustrated in FIG. 3C, a plurality of sharing groups (for example, friend, family, and co-worker) which can share a plurality of SNSs which the subscriber of the terminating terminal uses and each of the sharing groups differentially designates one or more SNSs to be shared. Accordingly, the setting unit 360 may newly set the contents to be shared of the terminating terminal or change and then set the contents.

Further, the transmitter 350 performs a function of transmitting new contents.

More specifically, when new contents related to the contents to be shared are input through the sharing service screen by the originating terminal 100, the transmitter 350 transmits the input new contents to the SNS server 400 and allows the SNS server 400 to register the received new contents as new SNS contents.

The new contents may be input through a new contents input area activated by selecting a particular UI button (message input) into the sharing service screen.

For example, when a particular UI button (message input) on the sharing service screen illustrated in FIG. 3A is selected, the sharing service screen may be switched to a service screen including a new contents input area illustrated in FIG. 3B. At this time, after one or more of the SNSs which the terminating terminal 200 designates to share with the originating terminal 100 are selected, new contents may be input into the new content input area.

When the transmitter 350 receives new contents related to one or more SNSs from the originating terminal 100, the transmitter 300 transmits the new contents to respective SNS servers 400 and registers the new contents as new SNS contents.

Further, after transmitting the new contents transmitted from the originating terminal 100 to the SNS server 400, the transmitter 350 registers the new contents as update information. Accordingly, when the generator 330 generates the sharing service screen in the future, the registered update information can be used.

In addition, after registering the update information related to the new contents, the transmitter 350 informs the terminating terminal 200 that the new contents has been registered in the SNS server 400. Accordingly, the terminating terminal 200 may access the SNS server 400 to identify the new contents registered as the new SNS contents.

Meanwhile, the transmitter 350 may newly register new contents transmitted from the terminating terminal 100 through the setting service screen by transmitting the new contents to the SNS server 400 as well as the new contents transmitted from the originating terminal 100 through the sharing service screen.

For example, when a particular UI button (message input) on the setting service screen illustrated in FIG. 3C is selected, the setting service screen may be switched to a service screen including a new contents input area illustrated in FIG. 3B. At this time, after one or more of the SNSs which the terminating terminal 200 has joined are selected, new contents may be input into the new content input area.

When the transmitter 350 receives new contents related to one or more SNSs from the terminating terminal 200, the transmitter 300 transmits the new contents to respective SNS servers 400 and registers the new contents as new SNS contents.

At this time, the transmitter 350 may also transmit authentication information of the terminating terminal 200 according to a request of the SNS server 400.

For reference, the new contents transmitted from the terminating terminal 200 may be directly transmitted to the SNS server 400 without passing through the service server 300.

Further, after transmitting the new contents transmitted from the terminating terminal 200 to the SNS server 400, the transmitter 350 registers the new contents as update information. Accordingly, when the generator 330 generates the sharing service screen in the future, the registered update information can be reflected.

The setting service screen may be generated to allow the subscriber of the terminating terminal 200 to set contents to be shared as well as the input of the new contents.

When the transmitter 350 receives information related to the setting of the contents to be shared from the terminating terminal 200 through the setting service screen, the transmitter 350 allows the setting unit to register the information and thus the registered information can be reflected when the generator 330 generates the sharing service screen or the setting service screen in the future.

As described above, according to the contents sharing service system according to the embodiment of the present invention, in connection with the voice call connection made between the originating terminal 100 and the terminating terminal 200, the subscriber of the terminating terminal 200 sets contents which the subscriber of the terminating terminal 200 desires to share with the subscriber of the originating terminal 100 and the originating terminal 100 may identify the set contents to be shared. Accordingly, registered SNS contents related to a plurality of SNSs which the subscriber of the terminating terminal 200 has joined can be easily shared with the subscriber of the originating terminal 100 as the contents to be shared.

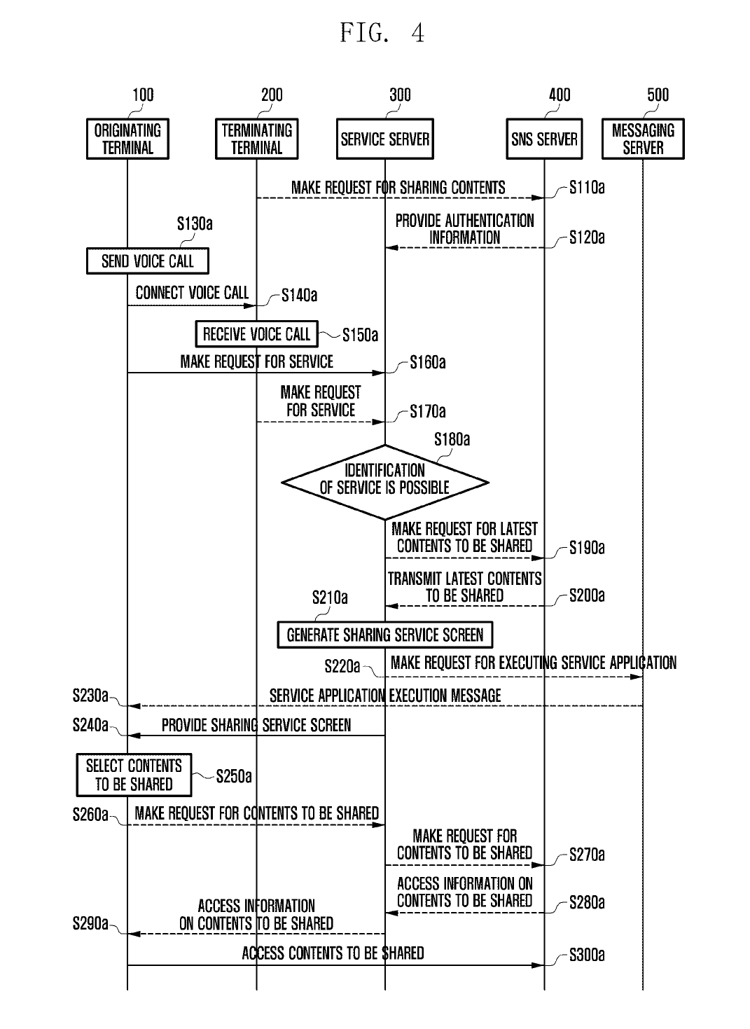

Hereinafter a contents sharing service method according to an embodiment of the present invention will be described with reference to FIGS. 4 to 10.

The configurations identical to those illustrated in FIGS. 1 to 2 are assigned the same corresponding reference numerals for the convenience of a description.

First, an operation flow in a contents sharing service system according to a first embodiment of the present invention will be described with reference to FIG. 4.

The terminating terminal 200 transmits a contents sharing request to the SNS server 400 that provides each SNS to inform of the desire to share the corresponding SNS and accordingly allows the SNS server 400 to provide authentication information corresponding to an authority to access the contents to be shared to the service server 300 in S110a to S120a.

Then, the service server 300 receives a service request for using a contents sharing service from the originating terminal 100 that sends a voice call during a voice call connection process between the originating terminal 100 and the terminating terminal 200, the terminating terminal 200 that receives the voice call, or both the originating terminal 100 and the terminating terminal 200 in S130a to S170a.

Next, the service server 300 identifies whether the contents sharing service with respect to the originating terminal 100 and the terminating terminal 200 is possible according to the reception of the service request from the originating terminal 100 or the terminating terminal 200 in S180a.

When the service server 300 receives the service request from the originating terminal 100, the service server 300 first identifies whether the subscriber of the terminating terminal 200 has joined the contents sharing service. When the subscriber of the terminating terminal 200 has joined the contents sharing service, the service server 300 identifies whether there are contents which the terminating terminal 200 desires to share with the originating terminal 100.

That is, the service server 300 may identify whether the contents exist which the terminating terminal 200 desires to share with the originating terminal 100 by identifying whether there is an SNS which the subscriber of the terminating terminal 200 designates to share with the subscriber of the originating terminal 100 in a plurality of SNSs which the subscriber of the terminating terminal 200 uses.

In contrast, when the service server 200 receives the service request from the terminating terminal 200, the service server 200 identifies whether the contents exist which the subscriber of the terminating terminal 200 desires to share with the originating terminal 100 as described above. When the service server 200 identifies that the contents to be shared exist, the service server 200 identifies whether a service application is installed in the originating terminal 100.

Next, when the service server 300 identifies that the contents exist which the subscriber of the terminating terminal 200 desires to share with the subscriber of the originating terminal 100, the service server 300 generates a sharing service screen including the contents to be shared in S190a to S210a.

The service server 200 identifies the SNS which the subscriber of the terminating terminal 200 designates to share with the subscriber of the originating terminal 100 and acquires SNS contents registered by the subscriber of the terminating terminal 200 from the SNS server 300 providing the corresponding SNS. Accordingly, the service server 300 can generate the sharing service screen including the acquired SNS contents as the contents to be shared.

As described above, in order to generate the sharing service screen, the service server 200 may directly acquire the SNS contents registered by the subscriber of the terminating terminal 200 from the SNS server 300 but actually makes a request for the SNS contents to the terminating terminal 200. Accordingly, the terminating terminal 200 acquires newly registered SNS contents from the SNS server 300 and transmits the acquired SNS contents to the service server 200 as latest contents to be shared.

Then, when the sharing service screen is generated, the service server 300 provides the sharing service screen to the originating terminal 100 and thus may allow the subscriber of the originating terminal 100 to identify, through the sharing service screen, the contents which the subscriber of the terminating terminal 200 desires to share in S220a to S300a.

First, when the service request is not received from the originating terminal 100, a state may be expected where the service application is installed in the originating terminal 100 but the service application is not executed.

In this event, the service server 300 transmits a service application execution request to the messaging server 500 and allows the messaging server 500 to transmit a service application execution message to the originating terminal 100, so that the service application installed in the originating terminal 100 is executed and the originating terminal 100 may normally receive and display the sharing service screen.

The service server 300 provides authentication information required for an access to the SNS server 400 together with access information on each of the contents to be shared included in the sharing service screen. Accordingly, when the originating terminal 100 selects the contents to be shared in the sharing service screen, the service server 300 allows the originating terminal 100 to directly access the contents to be shared, that is, SNS contents registered in the SNS server 400 without separate service subscription and authentication processes in the SNS server 400.

Meanwhile, when the service server 300 does not provide the access information and authentication information on each of the contents to be shared included in the sharing service screen and the originating terminal 100 selects the contents to be shared in the sharing service screen, the service server 300 may allow a contents request to be transmitted to the service server 300.

In this event, by transmitting the contents request received from the originating terminal 100 to the SNS server 400, the service server 300 acquires the authentication information on the corresponding contents to be shared from the SNS server 400 and transmits the access information on the acquired contents to be shared to the originating terminal 100.

In transmitting the contents request received from the originating terminal 100 to the SNS server 400, the service server 300 may transmit in advance the authentication information required for the access to the SNS server 400, so that the originating terminal 100 can access the contents to be shared, that is, SNS contents registered in the SNS server 400 according to the access information on the contents to be shared without separate service subscription and authentication processes in the SNS server 400.

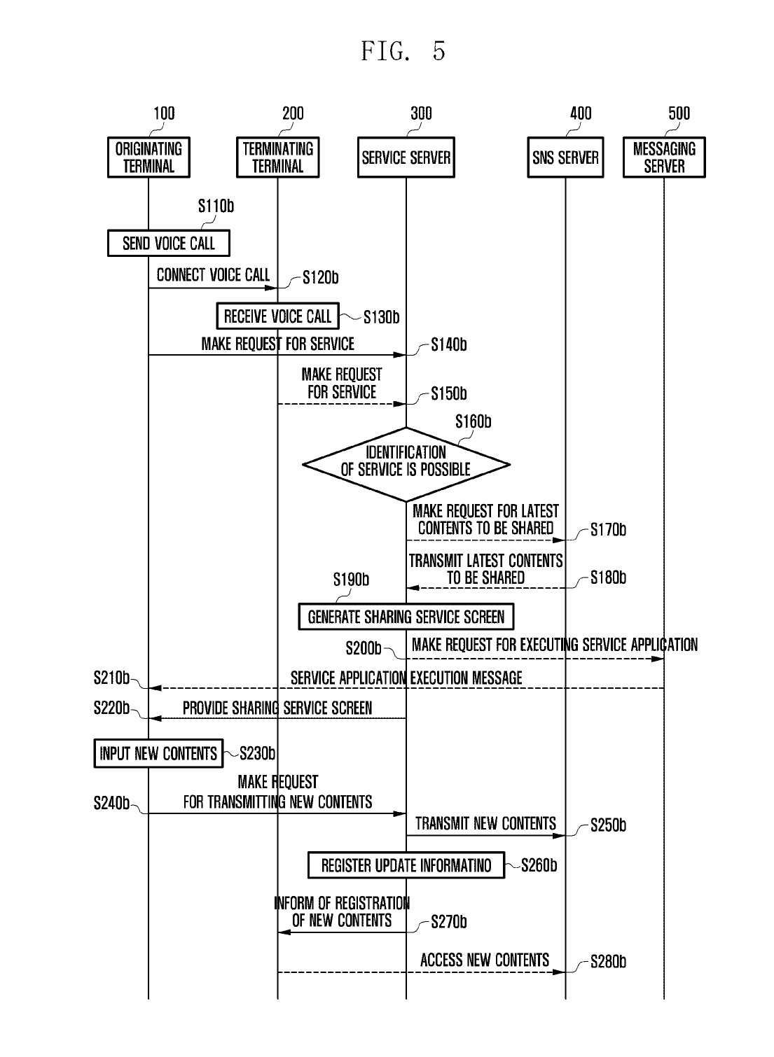

Hereinafter, an operation flow in a contents sharing service system according to a second embodiment of the present invention will be described with reference to FIG. 5.

Meanwhile, since steps from step S110b in which the originating terminal 100 sends a voice call to step S220b in which the service server 300 provides a sharing service screen to the originating terminal 100 during the operation flow in the contents sharing service system according to the second embodiment of the present invention are the same as steps from step 130a in which the originating terminal 100 sends the voice call to step S240a in which the service server 300 provides the sharing service screen to the originating terminal 100 during the operation flow in the contents sharing service system according to the first embodiment of the present invention described with FIG. 4, descriptions of steps 110b to S220b will be omitted.

First, when new contents related to the contents to be shared are input through the sharing service screen after the sharing service screen is provided to the originating terminal 100, the service server 300 transmits the input new contents to the SNS server 400 and allows the SNS server 400 to register the received new contents as new SNS contents in S230b to S250b.

Then, after transmitting the new contents transmitted from the originating terminal 100 to the SNS server 400, the service server 300 registers the new contents as update information. Accordingly, when the sharing service screen is generated according to a service request in the future, the registered update information can be used in step S260b.

Next, after registering the update information related to the new contents, the service server 300 informs the terminating terminal 200 that the new contents has been registered in the SNS server 400. Accordingly, the terminating terminal 200 may access the SNS server 400 to identify the new contents registered as the new SNS contents in S270b to S280b.

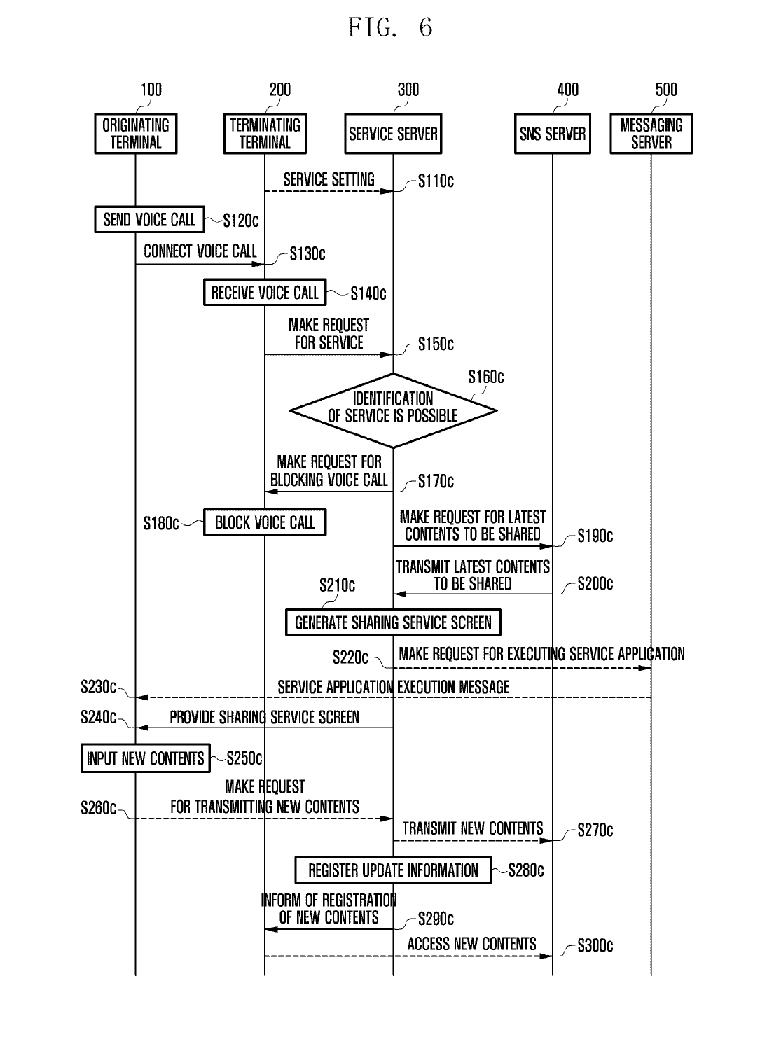

Hereinafter an operation flow in a contents sharing service system according to a third embodiment of the present invention will be described with reference to FIG. 6.

Meanwhile, since steps from step S190c in which the service server 300 acquires contents to be shared from the SNS server 400 to step S330c in which the terminating terminal 200 accesses the SNS server 400 to identify new contents during the operation flow in the contents sharing service system according to the third embodiment of the present invention are the same as steps from step 170b in which the service server 300 acquires the contents to be shared from the SNS server 400 to step S280b in which the terminating terminal 200 accesses the SNS server 400 to identify the new contents during the operation flow in the contents sharing service system according to the second embodiment of the present invention described with FIG. 5, descriptions of steps 190c to S330c will be omitted.

First, when the terminating terminal 200 accesses the service server 300 to receive a voice call from the originating terminal 100 in a state where a voice call connection is difficult (for example, in a cinema, in class, or in a meeting), a voice call blocking service corresponding to an additional service in which the voice call connection is stopped and the originating terminal 100 identifies the contents which the terminating terminal 200 sets to share in S110c is set.

Then, the service server 300 identifies whether the contents sharing service with respect to the originating terminal 100 and the terminating terminal 200 is possible according to the reception of the service request from the originating terminal 100 or the terminating terminal 200 in S120c to S160c.

The service server 200 identifies whether the contents exist which the subscriber of the terminating terminal 200 desires to share with the originating terminal 100 as the service request is received from the terminating terminal 200. When the service server 200 identifies that the contents to be shared exist, the service server 200 identifies whether a service application is installed in the originating terminal 100.

Next, the service server 300 identifies whether the terminating terminal 200 has joined the voice call blocking service. When the terminating terminal 200 has joined the voice call blocking service, the service server 300 makes a request for stopping a voice call connection to the terminating terminal 200 and allows the originating terminal 100 to identify the set contents which the terminating terminal 200 desires to share in S170c to S180c.

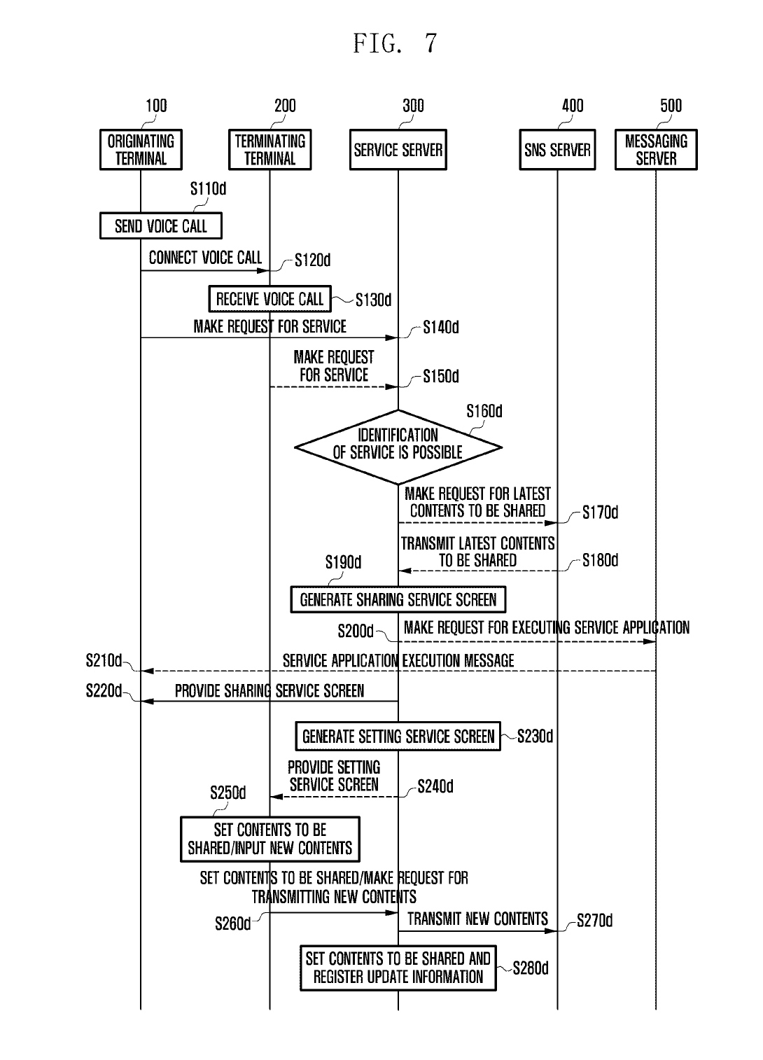

Hereinafter an operation flow in a contents sharing service system according to a fourth embodiment of the present invention will be described with reference to FIG. 7.

Meanwhile, since steps from step S110d in which the originating terminal 100 sends a voice call to step S220d in which the service server 300 provides a sharing service screen to the originating terminal 100 during the operation flow in the contents sharing service system according to the fourth embodiment of the present invention are the same as steps from step 130a in which the originating terminal 100 sends the voice call to step S240a in which the service server 300 provides the sharing service screen to the originating terminal 100 during the operation flow in the contents sharing service system according to the first embodiment of the present invention described with FIG. 4, overlapping descriptions will be omitted.

First, when there are no contents which the terminating terminal 200 desires to share with the originating terminal 100 or the sharing service screen is provided to the originating terminal 100, the service server 300 generates a setting service screen related to a setting of the contents to be shared and provides the generated setting service screen to the terminating terminal 200. Then, the terminating terminal 200 newly sets the contents which the terminating terminal 200 desires to share with the originating terminal 100 through the setting service screen or changes and then sets the contents in S230d to S240d.

Then, when new contents are input through the setting service screen after the setting service screen is provided to the terminating terminal 200, the service server 300 transmits the input new contents to the SNS server 400 and allows the SNS server 400 to register the received new contents as new SNS contents in S250b to S270b.

Next, after transmitting the new contents transmitted from the terminating terminal 200 to the SNS server 400, the service server 300 registers the new contents as update information. Accordingly, when the sharing service screen is generated according to a service request in the future, the registered update information can be used in S280d.

The service server 300 receives and registers information on the contents to be shared set by the subscriber of the terminating terminal 200 through the setting service screen as well as the new contents transmitted from the originating terminal 100 trough the setting service screen. Accordingly, the registered information may be reflected when the sharing service screen is generated or the setting service screen is generated in the future.

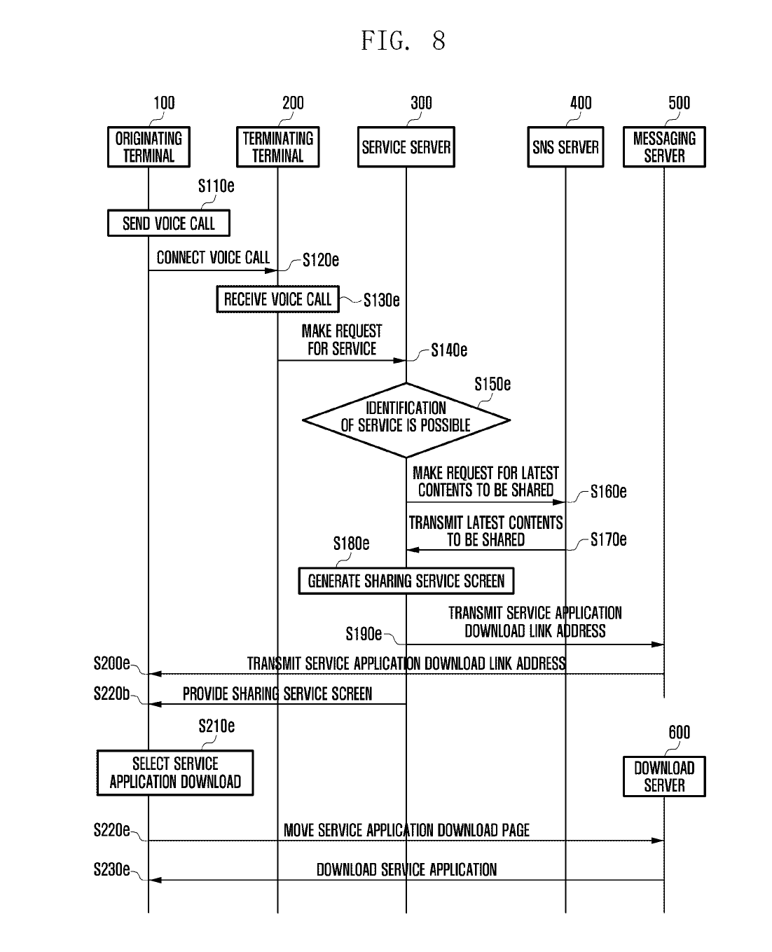

Hereinafter an operation flow in a contents sharing service system according to a fifth embodiment of the present invention will be described with reference to FIG. 8.

First, the service server 300 identifies whether the contents sharing service with respect to the originating terminal 100 and the terminating terminal 200 is possible according to the reception of the service request from the terminating terminal 200 in S110e to S150e.

The service server 300 identifies whether the contents exist which the subscriber of the terminating terminal 200 desires to share with the originating terminal 100 as the service request is received from the terminating terminal 200. When the service server 200 identifies that the contents to be shared exist, the service server 200 identifies whether a service application is installed in the originating terminal 100.

Then, when the service server 300 identifies that the contents exist which the subscriber of the terminating terminal 200 desires to share with the subscriber of the originating terminal 100, the service server 300 generates a sharing service screen including the contents to be shared in S160e to S180e.

The service server 200 identifies the SNS which the subscriber of the terminating terminal 200 designates to share with the subscriber of the originating terminal 100 and acquires SNS contents registered by the subscriber of the terminating terminal 200 from the SNS server 300 providing the corresponding SNS. Accordingly, the service server 300 can generate the sharing service screen including the acquired SNS contents as the contents to be shared.

Next, when the service server 300 identifies that a service application is not installed in the originating terminal 100, the service server 300 transmits a service application download link address to the messaging server 500 to allow the messaging server 500 to transmit the service application download link address to the originating terminal 100 in S190e to S200e.

Thereafter, the originating terminal 100 accesses the download server 600 based on the service application download link address transmitted through the messaging server 500 to download and install a service application suitable for its own mobile platform in S210e to S230e.

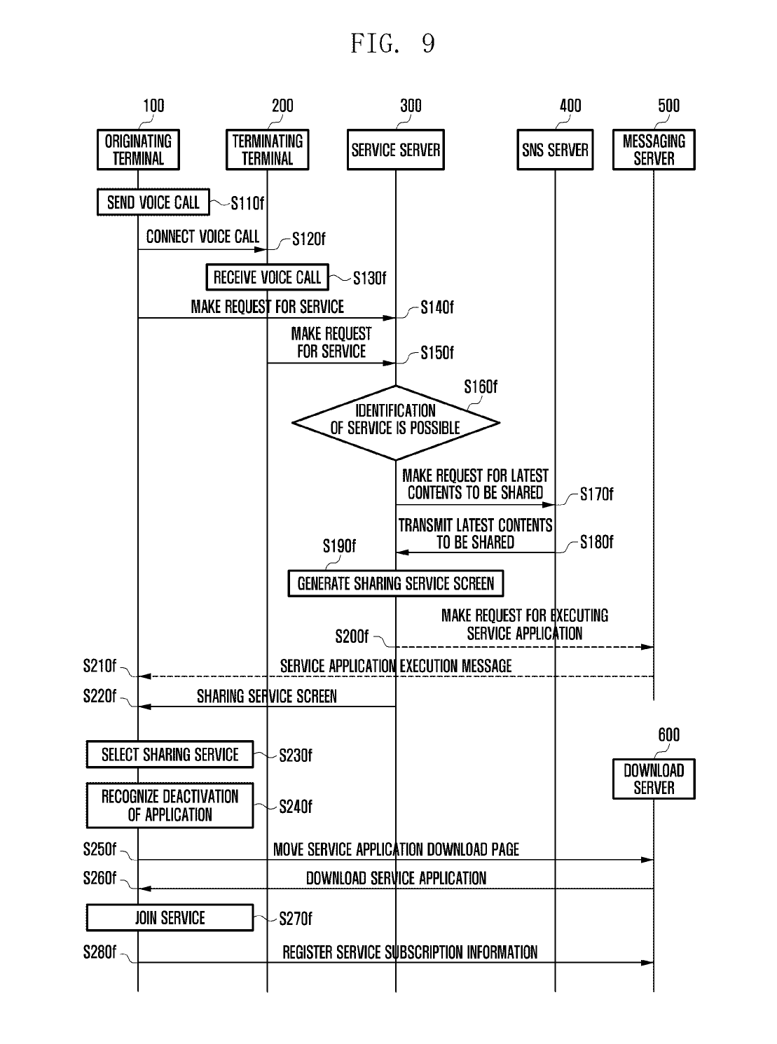

Hereinafter an operation flow in a contents sharing service system according to a sixth embodiment of the present invention will be described with reference to FIG. 9.

Meanwhile, since steps from step S110f in which the originating terminal 100 sends a voice call to step S220f in which the service server 300 provides a sharing service screen to the originating terminal 100 during the operation flow in the contents sharing service system according to the fourth embodiment of the present invention are the same as steps from step 130a in which the originating terminal 100 sends the voice call to step S240a in which the service server 300 provides the sharing service screen to the originating terminal 100 during the operation flow in the contents sharing service system according to the first embodiment of the present invention described with FIG. 4, overlapping descriptions will be omitted.

First, when the originating terminal 100 selects particular contents to be shared on the sharing service screen transmitted from the service server 300, the originating terminal 100 recognizes that the corresponding application is not executed even though the execution of the application is needed to identify the particular contents to be shared according to a service link in S230f to S240f.

Accordingly, as the originating terminal 100 recognizes that the application is not executed, the originating terminal 100 accesses an application download page provided by the download server 600 to download the corresponding application in S250f to S260f.

When the originating terminal 100 is required to perform a service subscription process in connection with the installation of the application, the originating terminal 100 registers service subscription information according to the corresponding service subscription process in the download server 600, so that the installed application can be normally executed in step S270f to S280f.

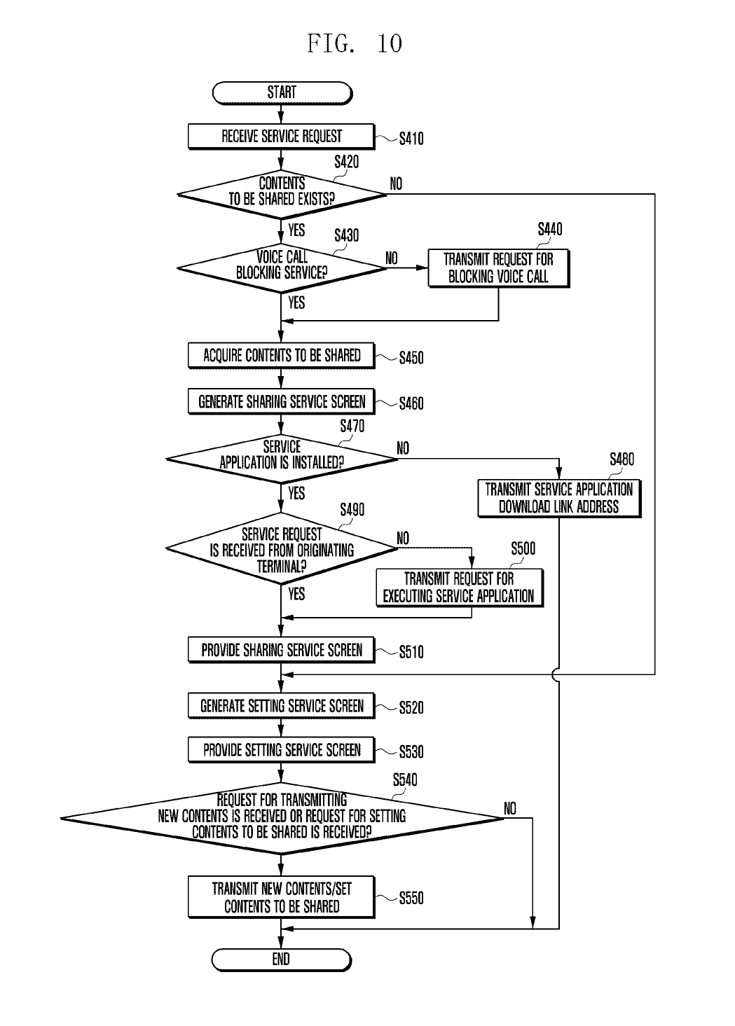

Hereinafter an operation method of the service server 300 according to an embodiment of the present invention will be described in more detail with reference to FIG. 10.

First, the receiver 310 receives a service request for using a contents sharing service from the originating terminal 100 that sends a voice call during a voice call connection process between the originating terminal 100 and the terminating terminal 200, the terminating terminal 200 that receives the voice call, or both the originating terminal 100 and the terminating terminal 200 in S410.

Then, the identifier 320 identifies whether a contents sharing service is possible according to the reception of the service request in S420.

When the service request is received from the originating terminal 100, the identifier 320 first identifies whether the subscriber of the terminating terminal 200 has joined the contents sharing service. When the subscriber of the terminating terminal 200 has joined the contents sharing service, the identifier 320 identifies whether there are contents which the terminating terminal 200 desires to share with the originating terminal 100.

In contrast, when the service request is received from the terminating terminal 200, the identifier 320 identifies whether the contents exist which the subscriber of the terminating terminal 200 desires to share with the originating terminal 100 as described above. When the identifier 320 identifies that the contents to be shared exist, the identifier 320 identifies whether a service application is installed in the originating terminal 100.

Next, the identifier 320 identifies whether the terminating terminal 200 has joined a voice call blocking service. When the terminating terminal 200 has joined the voice call blocking service, the identifier 320 makes a request for stopping a voice call connection to the terminating terminal 200 and allows the originating terminal 100 to identify the contents which the terminating terminal 200 sets to share in S430 to S440.

Next, only when it is identified that the contents exist which the subscriber of the terminating terminal 200 desires to share with the subscriber of the originating terminal 100, the generator 330 generates a sharing service screen including the contents to be shared in S450.

The generator 330 identifies the SNS which the subscriber of the terminating terminal 200 designates to share with the subscriber of the originating terminal 100 and acquires SNS contents registered by the subscriber of the terminating terminal 200 from the SNS server 300 providing the corresponding SNS. Accordingly, the generator 330 can generate the sharing service screen including the acquired SNS contents as the contents to be shared.

In a case where the service request is not received from the originating terminal 100, when the contents which the subscriber of the terminating terminal 200 desires to share with the subscriber of the originating terminal 100 exist but the service application is not installed in the originating terminal 100, the identifier 320 allows the provider 340 to download the service application and install the downloaded service application in the originating terminal 100 in S470 to S480.

The provider 340 transmits a service application download link address to the messaging server 500 and allows the messaging server 500 to transmit the service application download link address to the originating terminal 100, so that the originating terminal 100 downloads a service application suitable for its own mobile platform from the download server 600 and installs the downloaded service application.

Then, in the case where the service request is not received from the originating terminal 100, when the identifier 320 identifies that the contents which the subscriber of the terminating terminal 200 desires to share with the subscriber of the originating terminal 100 exist, the identifier 320 executes the service application installed in the originating terminal 100 to receive the sharing service screen through the provider 340 in S490 to S500.

The provider 340 transmits a service application execution request to the messaging server 500 and allows the messaging server 500 to transmit a service application execution message to the originating terminal 100, so that the service application installed in the originating terminal 100 is executed and the originating terminal 100 may normally receive and display the sharing service screen.

Next, when the sharing service screen is generated, the provider 340 provides the sharing service screen to the originating terminal 100 and thus may allow the subscriber of the originating terminal 100 to identify, through the sharing service screen, the contents which the subscriber of the terminating terminal 200 desires to share in S510.

The provider 340 provides authentication information required for an access to the SNS server 400 together with access information on each of the contents to be shared included in the sharing service screen. Accordingly, when the originating terminal 100 selects the contents to be shared in the sharing service screen, the provider 340 allows the originating terminal 100 to directly access the contents to be shared, that is, SNS contents registered in the SNS server 400 without separate service subscription and authentication processes in the SNS server 400.

In contrast, when the provider 340 does not provide the access information and authentication information on each of the contents to be shared included in the sharing service screen and the originating terminal 100 selects the contents to be shared in the sharing service screen, the provider 340 may allow a contents request to be transmitted to the provider 340 itself.

In this event, by transmitting the contents request received from the originating terminal 100 to the SNS server 400, the provider 340 acquires the access information on the corresponding contents to be shared from the SNS server 400 and transmits the access information on the acquired contents to be shared to the originating terminal 100.

In transmitting the contents request received from the originating terminal 100 to the SNS server 400, the provider 340 may transmit in advance the authentication information required for the access to the SNS server 400, so that the originating terminal 100 can access the contents to be shared, that is, SNS contents registered in the SNS server 400 according to the access information on the contents to be shared without separate service subscription and authentication processes in the SNS server 400.

When there are no contents which the terminating terminal 200 desires to share with the originating terminal 100 or the sharing service screen is provided to the originating terminal 100, the generator 330 generates a setting service screen related to a setting of the contents to be shared and allows the generated setting service screen to be provided to the terminating terminal 200 through the provider 340. Then, the terminating terminal 200 newly sets the contents which the terminating terminal 200 desires to share with the originating terminal 100 through the setting service screen or changes and sets the contents in S520 to S530.

Thereafter, when new contents related to the contents to be shared are input through the sharing service screen by the originating terminal 100, the transmitter 350 transmits the input new contents to the SNS server 400 and allows the received new contents to be registered as new SNS contents by the SNS server 400.

The transmitter 350 may newly register new contents transmitted from the terminating terminal 200 through the setting service screen by transmitting the new contents to the SNS server 400 as well as the new contents transmitted from the originating terminal 100 through the sharing service screen.

Meanwhile, when information related to the setting of the contents to be shared is received from the terminating terminal 200 through the setting service screen, the transmitter 350 allows the information to be registered by the setting unit and thus the registered information can be reflected when the generator 330 generates the sharing service screen or the setting service screen in the future.

As described above, according to the contents sharing service system according to the embodiment of the present invention, in connection with the voice call connection made between the originating terminal 100 and the terminating terminal 200, the subscriber of the terminating terminal 200 sets contents which the subscriber of the terminating terminal 200 desires to share with the subscriber of the originating terminal 100 and the originating terminal 100 may identify the set contents to be shared. Accordingly, registered SNS contents related to a plurality of SNSs which the subscriber of the terminating terminal 200 has joined can be easily shared with the subscriber of the originating terminal 100 as the contents to be shared.

Meanwhile, the method or algorithm steps described in connection with the embodiments disclosed herein may be directly implemented by hardware, a software module executed by a processor, or a combination thereof. The software module may be located at a Random Access Memory (RAM), a flash memory, a Read Only Memory (ROM), an Erasable Programmable ROM (EPROM), an Electrically EPROM (EEPROM), registers, a hard disc, a removable disc, a Compact Disc (CD)-ROM, or a technically known storage medium having another random type. Examples of the storage medium may be connected with a processor, and accordingly, the processor may read information from the storage medium and record information in the storage medium. Alternatively, the storage medium may be integrated into the processor. The processor and the storage medium may be included within an Application Specific Integrated Circuit (ASIC). The ASIC may be included within a user terminal. Alternatively, the processor and the storage medium may be included within the user terminal as individual components.

Although the present invention has been described in detail with reference to exemplary embodiments, the present invention is not limited thereto and it is apparent to those skilled in the art that various modifications and changes can be made thereto without departing from the scope of the present invention.

### INDUSTRIAL APPLICABILITY

According to a method of sharing contents and a server applied to the same according to an embodiment of the present invention, in that a terminating terminal sets contents which the terminating terminal desires to share with an originating terminal in regard to a voice call connection made between the originating terminal and the terminating terminal and the originating terminal identifies the set contents to be shared, the present invention overcomes limitations of the conventional technologies. Further, devices to which the present invention is applied have a high probability of entering into the market and being sold beyond simply using the related technologies. Accordingly, the present invention can be obviously implemented in reality and is highly applicable to the industries.

1. A service server comprising:
an identifier for identifying whether there are contents to be shared which a terminating terminal sets to share with an originating terminal according to a service request received in regard to a voice call connection between the terminating terminal and the originating terminal;
a generator for generating a sharing service screen to include the contents to be shared when it is identified that there are the contents which the terminating terminal sets to share with the originating terminal; and
a provider for providing the sharing service screen to the originating terminal to allow the originating terminal to identify the contents which the terminating terminal sets to share through the sharing service screen.

2. The service server of claim 1, wherein the generator generates a setting service screen related to a setting of the contents to be shared when the identifier identifies that there are no contents which the terminating terminal sets to share with the originating terminal or the provider provides the sharing service screen to the originating terminal, and the provider provides the setting service screen to the terminating terminal to allow the terminating terminal to newly set contents to be shared with the originating terminal or to change and then set the contents.

3. The service server of claim 1, wherein the contents to be shared include Social Network Service (SNS) contents registered in connection with one or more SNSs which the terminating terminal designates to allow the originating terminal to access among a plurality of SNSs related to the terminating terminal, and the generator acquires the SNS contents registered in an SNS server providing each of the one or more SNSs from the SNS server and generates the sharing service screen to include the acquired SNS contents as the contents to be shared.

4. The service server of claim 3, wherein the sharing service screen and the setting service screen include a new contents input area through which new contents related to the one or more SNSs can be input, and the service server further comprises a transmitter for, when the new contents are input through the new contents input area by the originating terminal and the terminating terminal, transmitting the new contents to the SNS server providing each of the one or more SNSs and registering the new contents as the SNS contents.

5. The service server of claim 2, wherein a service application for receiving the sharing service screen or the setting service screen is installed in the originating terminal and the terminating terminal, and the service request is received from at least one of the originating terminal and the terminating terminal of which identification information has been identified in regard to the voice call connection through the service application.

6. An operation method of a service server, the operation method comprising:
identifying whether there are contents which a terminating terminal sets to share with an originating terminal according to a service request received in regard to a voice call connection made between the originating terminal and the terminating terminal;
generating a sharing service screen to include the contents to be shared when it is identified that there are the contents which the terminating terminal sets to share with the originating terminal; and
providing the sharing service screen to the originating terminal to allow the originating terminal to identify the contents which the terminating terminal sets to share through the sharing service screen.

7. The operation method of claim 6, further comprising:
generating a setting service screen related to a setting of the contents to be shared when it is identified that there are no contents which the terminating terminal sets to share with the originating terminal in the identifying of whether there are the contents; and
providing the setting service screen and newly setting the contents which the terminating terminal desires to share with the originating terminal through the setting service screen or changing and then setting the contents.

8. The operation method of claim 6, wherein the contents to be shared include SNS contents registered in connection with one or more SNSs which the terminating terminal designates to allow the originating terminal to access among a plurality of SNSs related to the terminating terminal, and
the generating of the sharing service screen comprises:
acquiring the SNS contents registered in an SNS server providing each of the one or more SNSs from the SNS server; and
generating the sharing service screen to include the acquired SNS contents as the contents to be shared.

9. The operation method of claim 8, wherein the sharing service screen and the setting service screen include a new contents input area through which new contents related to the one or more SNSs can be input, and
the operation method further comprising, when the new contents are input through the new contents input area by the originating terminal and the terminating terminal, transmitting the new contents to the SNS server providing each of the one or more SNSs and registering the new contents as the SNS contents

10. The operation method of claim 7, wherein a service application for receiving the sharing service screen or the setting service screen is installed in the originating terminal and the terminating terminal, and the service request is received from at least one of the originating terminal and the terminating terminal of which identification information have been identified in regard to the voice call connection through the service application.
